(19) United States
(12) Patent Application Publication
(10) Pub. No.: US 2012/0261967 A1
(43) Pub. Date: Oct. 18, 2012

(54) MOTOR-VEHICLE HEADREST

(76) Inventors: Marc AHLBRAND, Duesseldorf (DE); Alexander WILLIMS, Koeln (DE); Harald ROETTSCHES, Eschweller (DE)

(21) Appl. No.: 13/445,980

(22) Filed: Apr. 13, 2012

(30) Foreign Application Priority Data
Apr. 14, 2011 (DE) 102011017067.7
May 3, 2011 (DE) 102011100341.3

(51) Int. Cl. B60N 2/48

(52) U.S. Cl. 297/391

(57) ABSTRACT

A motor-vehicle headrest has a support-rod assembly adapted to be mounted on a motor-vehicle seat back, a base body carried on the rod assembly and having first fastening formations, and a hollow shell having generally complementary second fastening formations secured to the first fastening formations. A cushion is carried on the shell and base body.

### FIELD OF THE INVENTION

The present invention relates to a motor-vehicle headrest.

### BACKGROUND OF THE INVENTION

A headrest of this type is known in the prior art. Support rods anchored in a motor-vehicle seat back are fastened to a base body of the headrest. The base body is provided with a foam layer. The foam layer can be made, for example by molding of foam, and is mounted on the base body. Alternatively, for example the assembly of support rods and base body is held in a certain position in a mold. A cover, for example of a textile material, of leather or of synthetic leather, is placed into the mold, which cover later forms the surface of the head support part. Subsequently, foam is injected between the cover and the other parts in the mold so that the cover bears against the wall of the mold and the base body is molded in with foam. Different headrest shapes can be produced in this manner depending on the design of the mold.

In DE 10 2005 007 509 a headrest is described that has a cushion attached to a support. The cushion produced in this manner is connected in a rotatable manner to a base, to which the support rods are fastened.

DE 299 16 167 describes a headrest with a head cushion support part that is connected to a base. A gas bag, which can be inflated in order to move the head cushion support part in the direction of the head of a seat occupant, is arranged between the base and the head cushion carrier part.

### OBJECTS OF THE INVENTION

It is therefore an object of the present invention to provide an improved motor-vehicle headrest.

Another object is the provision of such an improved motor-vehicle headrest that overcomes the above-given disadvantages, in particular that has a low weight and that can be flexibly produced in different shapes.

### SUMMARY OF THE INVENTION

A motor-vehicle headrest has according to the invention a support-rod assembly adapted to be mounted on a motor-vehicle seat back, a base body carried on the rod assembly and having first fastening formations, and a hollow shell having generally complementary second fastening formations secured to the first fastening formations. A cushion is carried on the shell and base body.

In other words, the headrest comprises a base that is supported on support rods on a vehicle seat. A hollow body or shell is held on the base. The hollow body can be formed, for example by a dish-shaped or cup-shaped molded part. For example, the hollow body is formed by plastic injection molding. Alternatively, the hollow body can be made for example as a sheet metal part. At least one contact surface of the hollow body is formed, for example in a complementary manner to an outer surface of the base.

The hollow body is provided with an opening directed for example toward the base when the hollow body is mounted on the base. A cavity of the hollow body is then formed, for example, between an edge or rim defining the opening formed by the wall of the hollow body and an outer surface of the base. The edge is formed for example at least in part in a complementary manner to the outer surface and bears tightly against the outer surface of the base.

According to an alternative embodiment, the hollow body can also be essentially closed. In this case the cavity of the hollow body is formed essentially by the wall of the hollow body. The cavity can be filled with a gas, such as for example air, or for example with a light filler material. Subsequently, for example a foam molding can be mounted on the hollow body and the base. Alternatively, for example a cover is placed into the mold and subsequently foam is injected into the cover, so that the cover bears against the wall of the mold and the base held in a defined position to the mold is molded in with foam. Also in this embodiment, the hollow body has for example at least one contact surface that is embodied complementary to an outer surface of the base.

It is possible to reduce the weight of the headrest with the aid of the hollow body, since there is no weight-intensive cushioning foam in the cavity. Hollow bodies of different shapes can be attached to the base. In this way it is possible to flexibly change the shape of the headrest without having to change the base. Furthermore, for example the resistance against pressing in the head cushion of the headrest can be influenced by the hollow body. This is important in particular for headrests of vehicles that are operated in the US. Here a test process is carried out in which a test ball under a certain load may be pressed into the cushion only to a permissible degree.

One embodiment of the invention is characterized in that the hollow body is a cup-shaped shell. With this embodiment hollow bodies of any desired shape that have a low weight and form a cavity can be produced in a simple process. It can be made in a simple manner by deep drawing. Furthermore, it is easily possible to embody an edge surrounding the opening at least in part in a complementary manner to the outer surface of the base.

A further embodiment of the invention is characterized in that a contact surface of the hollow body is formed at least in part complementary to an outer surface of the base. When the hollow body has an opening on a side directed toward the base, an edge surrounding the opening can be complementary at least in part to the shape of an outer surface of the base. The contact surface of the hollow body can also be at least in part complementary to the outer surface of the base with a closed embodiment of the hollow body. The contact surface in both of the above-mentioned embodiments for example bears flush against the outer surface of the base. It is then easily possible to mold the base and the hollow body of foam, for example polyurethane foam, without the foam reaching into the cavity of the hollow body.

Another embodiment is characterized in that a seal is inserted between the outer surface of the base and the edge of the hollow body. This embodiment in addition prevents foam from being able to enter between the edge and the outer surface of the cavity during the molding in of the hollow body.

The hollow body has for example a first fastening means that correspond to first mating fastening means of the base. All of the fastening means of a group of hollow bodies correspond for example to the mating fastening means of a base.

A further embodiment of the invention is characterized in that the base has second fastening means to which at least second mating fastening means of a bracket can be fastened in a detachable manner. In this manner the shape of the headrest can be changed with simple means. For example, a prefabricated foam molding can be subsequently mounted on the base together with the bracket. Alternatively, for example the base with the bracket can be attached in a defined position to a mold and molded in with foam, as described above. Brackets of different shapes and dimensions can be connected to the base.

### BRIEF DESCRIPTION OF THE DRAWING

The above and other objects, features, and advantages will become more readily apparent from the following description, reference being made to the accompanying drawing in which:

FIG. 1 is a perspective view of a headrest according to the invention;

FIG. 2 is a perspective bottom view of a base of the headrest according to FIG. 1;

FIG. 3 is an exploded view of the headrest of FIG. 1;

FIG. 4 is a perspective and partly exploded view of the headrest of FIG. 1;

FIG. 5 is a rear elevational view of the headrest of FIG. 1;

FIG. 6 is a section taken along line VI-VI in FIG. 5;

FIG. 7 is a perspective view of another embodiment of the headrest of the invention;

FIG. 8 is a perspective view of the headrest of FIG. 7, with the head cushion removed;

FIG. 9 is a view like FIG. 8 but with a different support-rod assembly; and

FIG. 10 is a perspective and partly exploded view of a third embodiment of the headrest according to the invention.

### DETAILED DESCRIPTION

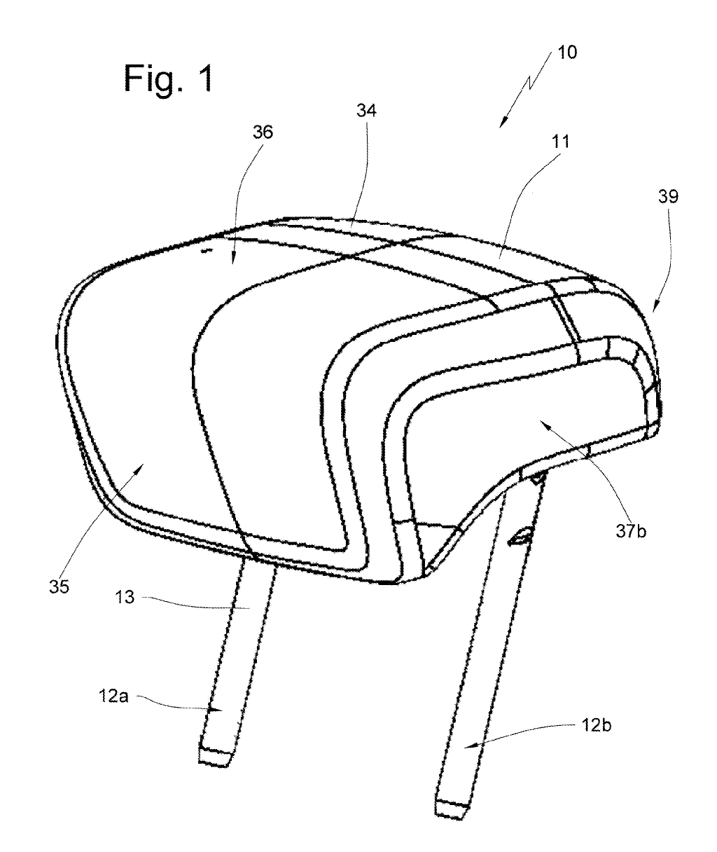

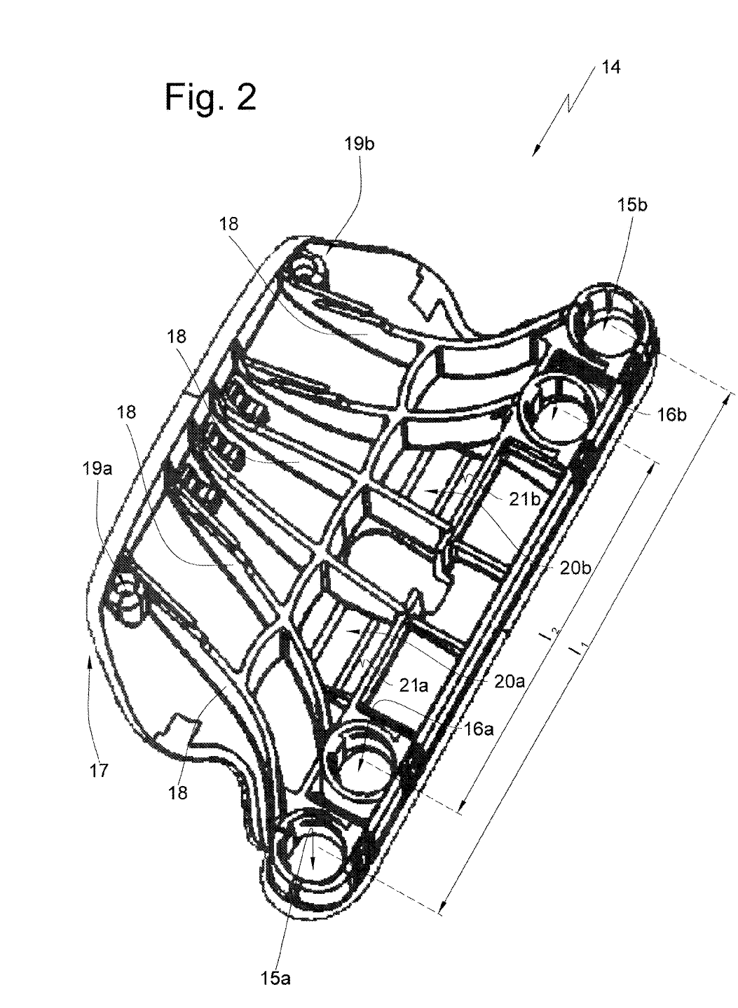

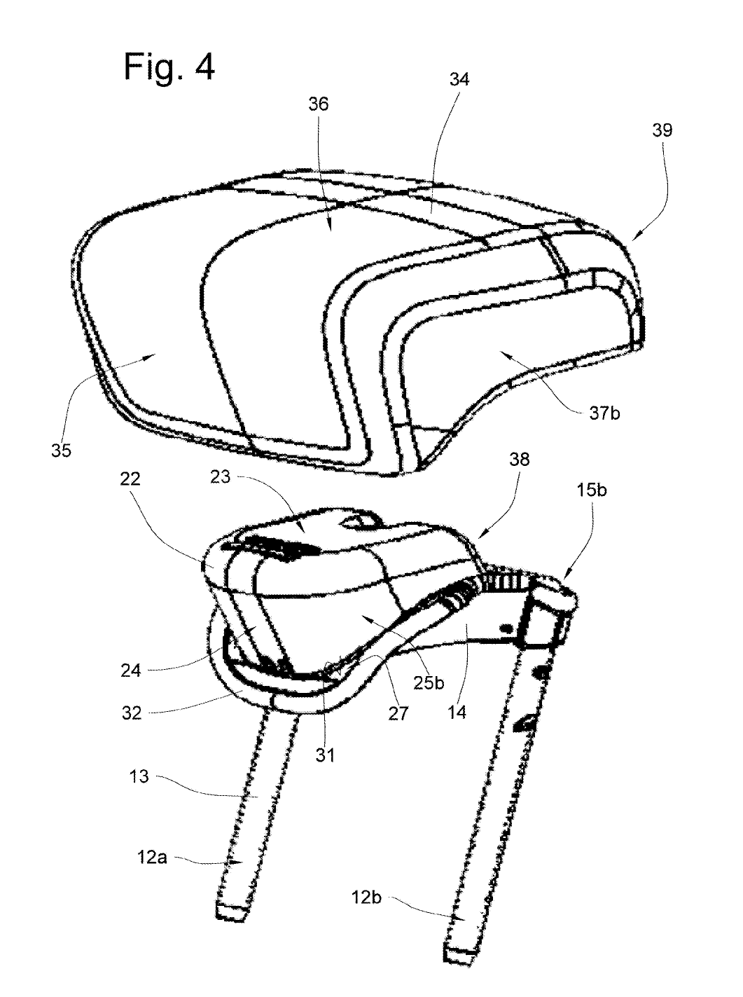

As seen in FIG. 1 a headrest 10 according to the invention has an cushioned head 11 carried on support rods 12a and 12b. In the illustrated embodiment the support rods 12a and 12b are upright and connected by a horizontal bight bar 41 to form a support-rod assembly 13 of inverted-U shape. The head 11 comprises a rigid base 14 shown in FIG. 2 and a cushion 34 (FIGS. 1 and 4) covering the base 14. Outer bushings 15a and 15b are formed in the base 14. They are set at a spacing 11 from one another. Furthermore, two inner bushings 16a and 16b are formed on the base 14 between the outer bushings 15a and 15b and serve for holding a second support-rod assembly. The bushings 156a and 16b have a spacing 12 from one another that is smaller than the spacing 11.

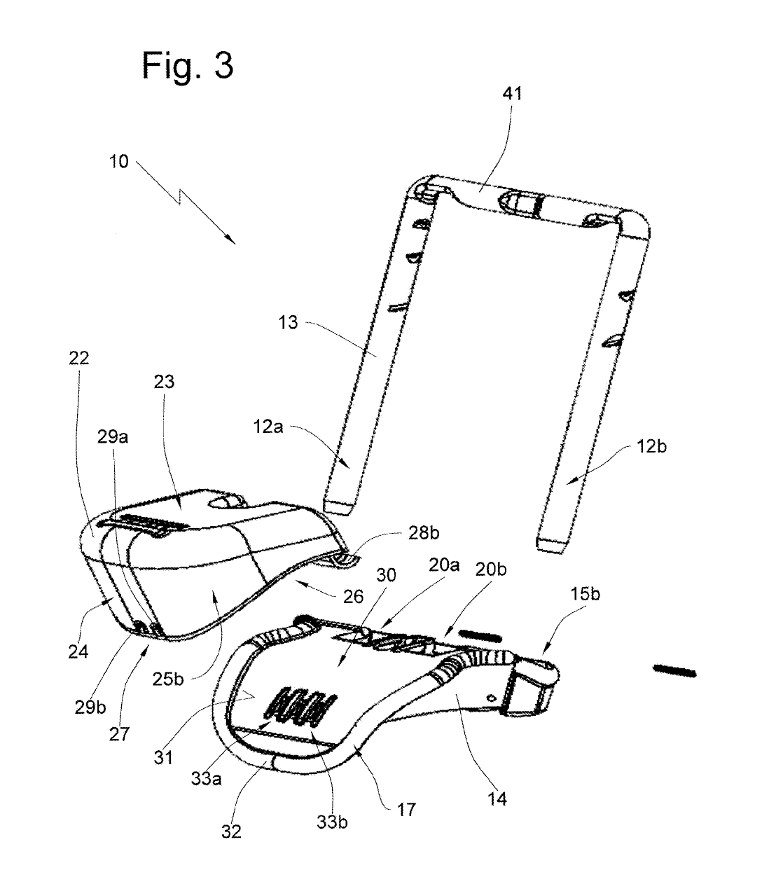

In the illustrated embodiment the base 14 is shaped to form a so-called L-shaped headrest. A front region 17 of the base 14 projects downward like a beak and is formed on its underside with stiffening ribs 18. A third pair of bushings 19a and 19b serve to hold a support bracket that is not shown in FIG. 2. The support bracket adapts the shape of the headrest to the desired dimensions. Bearing surfaces 21a and 21b are formed adjacent the openings 20a and 20b and serve to hold a hollow body shown in FIG. 3. The base 14 is made by plastic injection molding.

The headrest 10 comprises as shown in FIG. 3 the support-rod assembly 13, the base 14 as well as a hollow body or shell 22 that can be attached to the base 14. The hollow body 22 is dish-shaped and formed by plastic injection molding and comprises an top wall 23, a front wall 24 as well as two side walls of which only the side wall 25b is shown in FIG. 3. An open lower side 26 of the hollow body 22 is delimited by an edge 27. Upwardly hook-shaped brackets 28 extend rearward from the base 14.

The base 14 has on an upper side 30 an outer surface 31 having an outer edge 32 here formed with a bead. The outer surface 31 is smooth in particular adjacent the edge 32. The edge 27 is complementary to the outer surface 31 of the base 14. Fastening formations 29a and 29b are formed on the front wall 24. Holding formations 33a and 33b fixed in the base 14 are integrated in the outer surface 31 and can be engaged with the generally complementary fastening formations 29a and 29b.

FIG. 4 shows how the support-rod assembly 13 is mounted on the base 14. The support rods 12a and 12b engage through the outer bushings 15a and 15b. The support-rod assembly 13 has in a known manner latch notches that interact with unillustrated latch means of the seat back and make it possible to adjust the height of the base 14 relative the support-rod assembly 13.

The hollow body 22 is mounted on the base 14 in that the brackets 28 are inserted into the openings 20a and 20b until their free rear ends engage behind the webs 21a and 21b. Subsequently, the holding formations 33a and 33b are brought into engagement with the complementary formations 29a and 29b. According to FIG. 4 the hollow body 22 is mounted on the base 14. The edge 27 is a complementary to the edge 31 and lies flush against it.

Subsequently, the head cushion 34 can be mounted on the hollow body 22 and the base 14. In the illustrated embodiment shown, the head cushion 34 has been produced before assembly by separate molding of foam.

Alternatively, the head cushion could be produced in that the assembly unit of support-rod assembly, base 14 and hollow body 22 is attached to a mold. A cover is placed into the mold and subsequently foam is injected into the cover so that the cover bears against the wall of the mold and the base with the hollow body mounted thereon are molded in with foam. After the assembly of the head cushion, a front region 35 bears against the front wall 24 and an end region 36 bears against the end wall 23 of the hollow body 22. Side regions 37a and 37b bear against the side walls 25a and 25b. A rear region 39 of the head cushion 34 bears against a rear wall 38 of the hollow body 22.

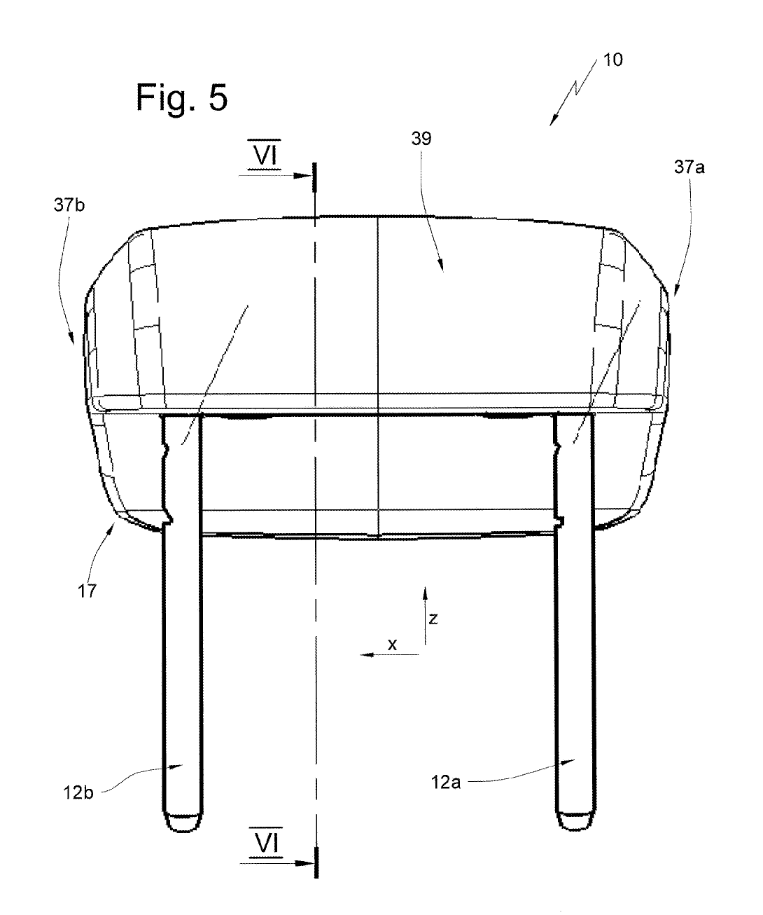

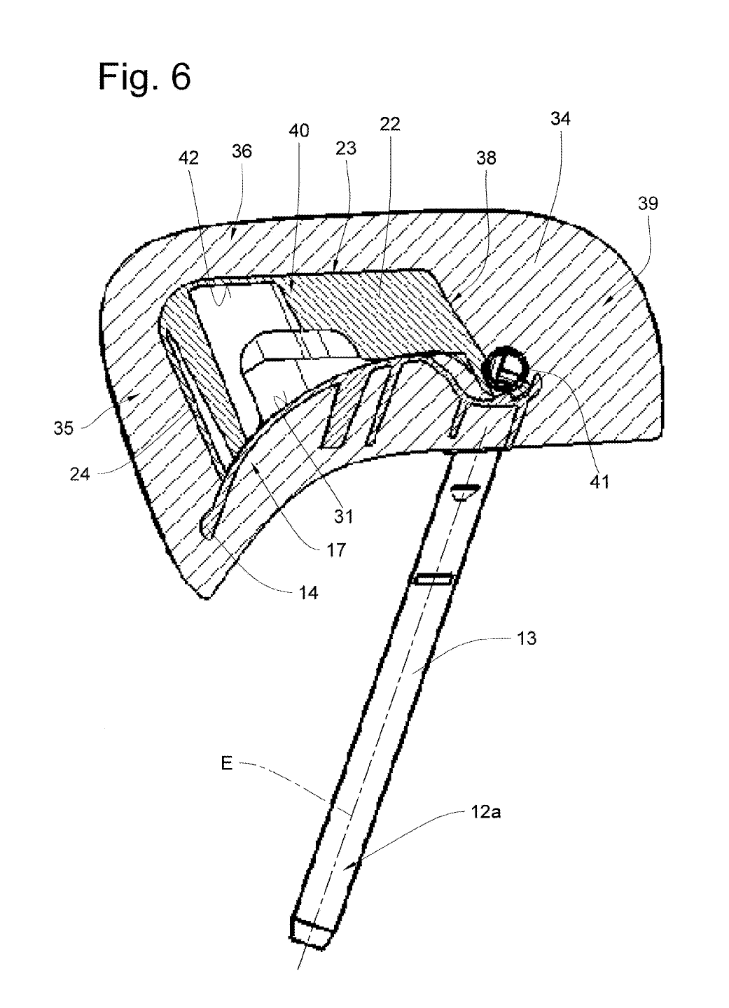

FIG. 5 shows how the front region 17 extends downward in an L-shape. According to FIG. 6 the front region 17 forms an acute angle to a plane E defined by axes of the parallel support rods 12a and 12b. An inner surface 42 of the hollow body 22 and the outer surface 31 of the base 14 form a cavity 40 that is here filled with air.

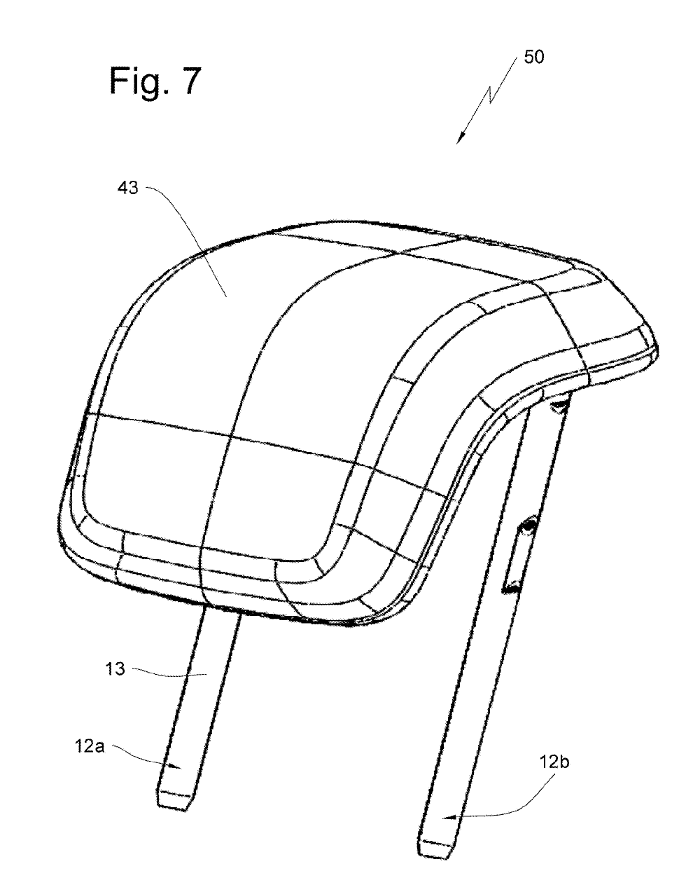

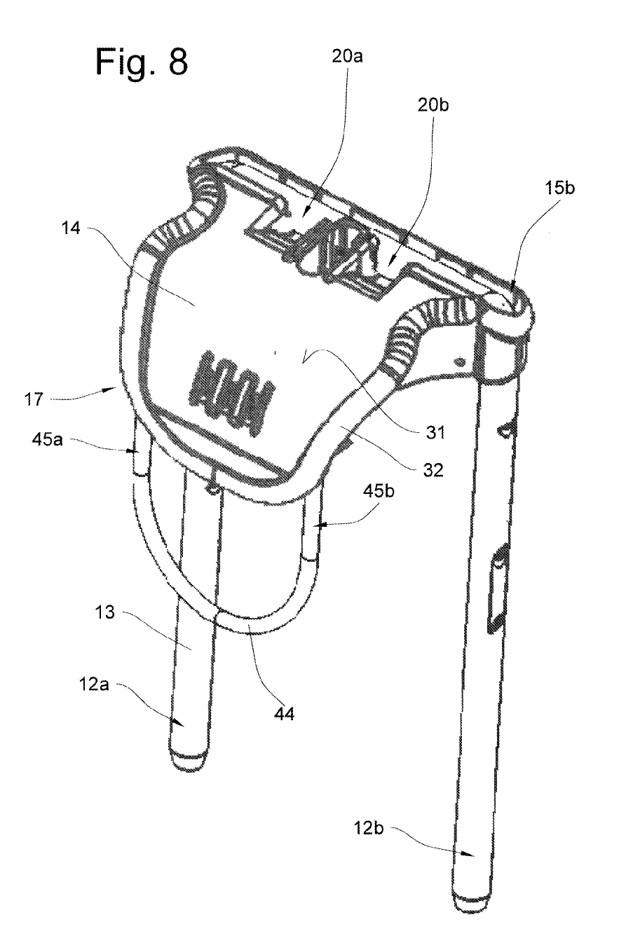

FIGS. 7 and 8 show a second embodiment 50 of the headrest according to the invention that is provided with a head cushion 43 that differs from the head cushion 34 with respect to dimensions and shape. The headrest 50 comprises the base 14, the support-rod assembly 13 and a support bracket 44 with free ends 45a and 45b. The ends 45a and 45b are secured in the bushings 19a and 19b. The support bracket 44 forms an extension of the front region 17 and serves as a frame that can be spanned by the head cushion 43 as shown in FIG. 7. Alternatively, in the case of this headrest 50 the head cushion could also be produced by casting in a mold as described with respect to the first illustrated embodiment. In the case of the headrest according to FIGS. 7 and 8, no hollow body 22 is mounted on the base 14. According to an alternative embodiment, not shown, the headrest 50 shown in FIGS. 7 and 8 could also be provided with a hollow body 22.

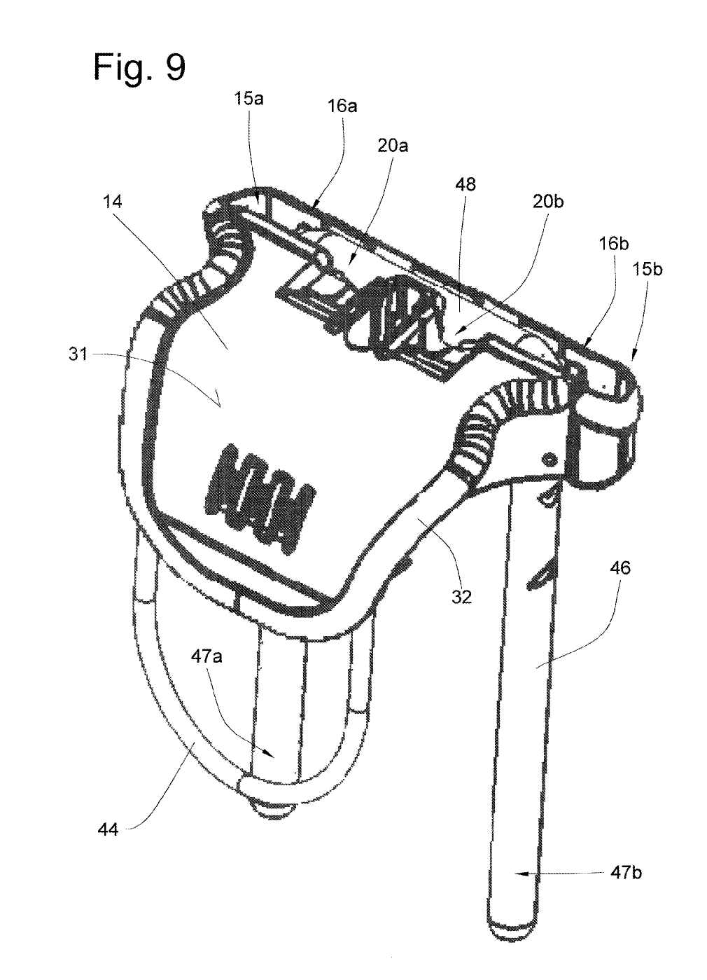

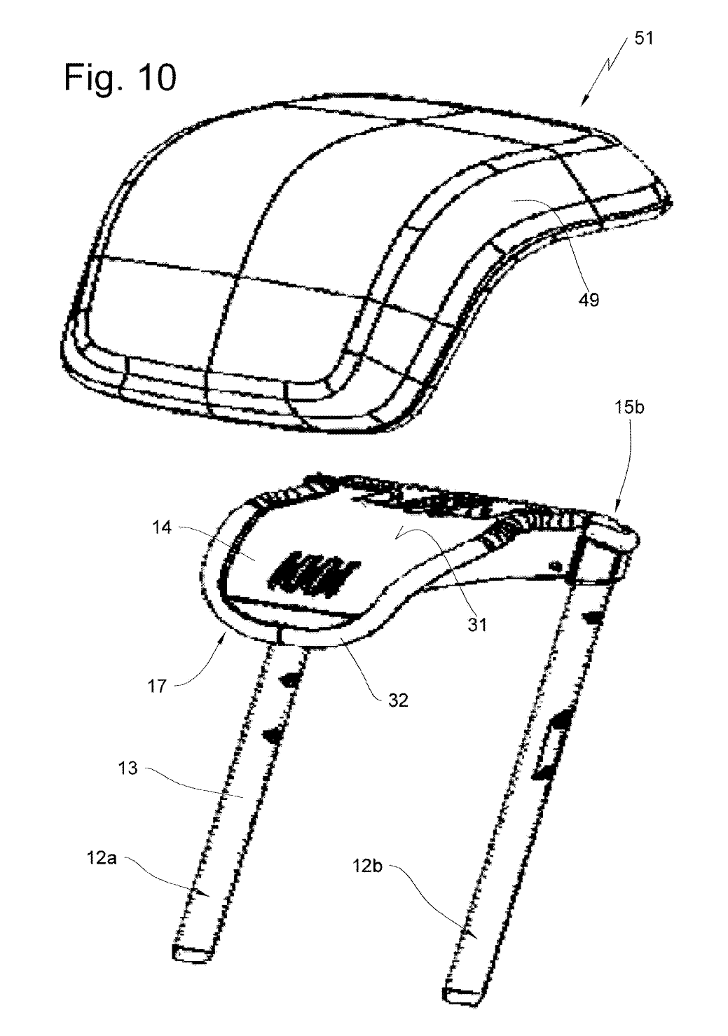

The embodiment shown in FIG. 9 differs from the embodiment of FIGS. 7 and 8 only in that a support-rod assembly 46 is mounted on the base 14. It has rod ends 47a and 47b that engage through the second bushings 16a and 16b. A crosspiece bar 48 of the support-rod assembly 46 is shorter than the crosspiece bar 41 of the support-rod assembly 13. Alternatively to the support-rod assembly 13, the support-rod assembly 46 can also be used with the illustrated embodiment shown in FIGS. 1 through 6 and an embodiment shown in FIG. 10.

With the embodiment of FIG. 10, a headrest 51 has the support-rod assembly 13, the base 14 and a head cushion 49. As already described above, the support-rod assembly 13 is mounted in the bushings 15a and 15b. The head cushion 49 is a foam molding mounted on the base 13. Alternatively, it is likewise possible to produce the head cushion 49 in that the base 14 is put in a mold, then a cover is placed into the mold, and then foam is injected into the mold so that the cover bears against the mold wall and the assembly of the base 14 and the hollow body 22 to surround them with foam.

Finally, it should be noted once again that the same base 13 is used in all of the embodiments. The base 13 can carry different support-rod assemblies, different hollow bodies, different head cushions and differently shaped support brackets on the fastening formations of the base 13. Furthermore it is possible to produce headrests with the base 13 and in which there is a support bracket and/or hollow body.

Each hollow body of a group of hollow bodies that can be combined with the contact surface 31 of the base 14 for example an edge 27 complementary to the shape of the contact surface 31 of the base 13 or a mating surface formed complementary to the contact surface 21. Furthermore, for example each hollow body has fastening formations that correspond to mating fastening formations of the base 13.

We claim:

1. A motor-vehicle headrest comprising:
a support-rod assembly adapted to be mounted on a motor-vehicle seat back;
a base body carried on the rod assembly and having first fastening formations;
a hollow shell having generally complementary second fastening formations secured to the first fastening formations; and
a cushion carried on the shell and base body.

2. The motor-vehicle headrest defined in claim 1, wherein the base body has a plurality of different first fastening formations, the shell being selected from a group of the shells each of whose second formations fit a respective one of the first fastening formations.

3. The motor-vehicle headrest defined in claim 2, wherein the shell is cup-shaped.

4. The motor-vehicle headrest defined in claim 3, wherein the shell and base body fit complementarily together.

5. The motor-vehicle headrest defined in claim 4, wherein the shell is concave toward the base body, and defines a space therewith, and the first and second formations are edges surrounding the space.

6. The motor-vehicle headrest defined in claim 5, further comprising a seal between the first and second formations.

7. The motor-vehicle headrest defined in claim 3, wherein the base body has two such fastening formations and the hollow shell has two such second fastening formations.

8. The motor-vehicle headrest defined in claim 7 wherein the first formations are sockets and the second formations are rod ends that fit in the sockets.
